(19) United States
(12) Patent Application Publication
(10) Pub. No.: US 2021/0391992 A1
(43) Pub. Date: Dec. 16, 2021

(54) MANAGING CLIENT AUTHORISATION

(71) Applicant: Hewlett-Packard Development Company, L.P., Spring, TX (US)

(72) Inventors: Joshua Serratelli Schiffman, Bristol (GB); Remy Husson, Bristol (GB); Thalia May Laing, Bristol (GB)

(73) Assignee: Hewlett-Packard Development Company, L.P., Spring, TX (US)

(21) Appl. No.: 17/283,367

(22) PCT Filed: Dec. 5, 2018
(86) PCT No.: PCT/US2018/064131

§ 371 Date: Apr. 7, 2021

(51) Int. Cl. H04L 9/32

(52) U.S. Cl. CPC H04L 9/3213; H04L 2209/38; H04L 9/3236; H04L 9/3247

(57) ABSTRACT

A method comprising: receiving, by a blockchain maintainer, a client request for a cryptographic token, the cryptographic token to allow the client to access a particular service from a service provider; processing, by the blockchain maintainer, the request using a blockchain smart contract to determine if the client request is valid; if the client request is determined to be valid, including the client request in the blockchain; generating, by a token issuer, the requested cryptographic token in response to inclusion of the valid client request in the blockchain; and issuing the generated cryptographic token to the client.

### BACKGROUND

Managing client authorisation may involve, for example, verifying that a client is authorised to access a particular service from a service provider. This may be achieved, for example, by issuing the client with an authorisation to indicate that the client is authorised.

### BRIEF INTRODUCTION OF THE DRAWINGS

Various features of the present disclosure will be apparent from the detailed description which follows, taken in conjunction with the accompanying drawings, which together illustrate features of the present disclosure, and wherein:

FIG. 1 shows a schematic representation of issuing an authorisation token to a client according to an example of the disclosure;

FIG. 2 shows a schematic representation of issuing an authorisation token to a client according to an example of the disclosure;

FIG. 3 shows a schematic representation of issuing an authorisation token to a client according to an example of the disclosure;

FIG. 4 shows a schematic representation of issuing an authorisation token to a client according to an example of the disclosure;

FIG. 5 shows a schematic representation of issuing an authorisation token to a client according to an example of the disclosure; and

FIG. 6 shows example methods according to examples of the disclosure.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Issuing authorisation to a client to allow access to a service may take place by a central authorisation issuer managing authorisation issuance, and maintaining a record of the authorisations which have been issued (for example to which clients they have been issued, when, and for what services). It may be challenging to maintain a clear record of the authorisations which have been issued and control a client's access to services in a secure and effective way.

Verifying that a client is authorised to access a particular service from a service provider may be achieved, for example, by issuing the client with an authorisation, such as an electronic token to indicate that the client is authorised. Such an electronic token may be likened in some examples to an electronic certificate certifying that the client has the authorisation to access the requested service. Issuing authorisation tokens may rely on a token issuer to enforce a token issuing policy that is consistent across an administrative domain. It may be difficult to maintain this policy, and record how many tokens have been issued or to efficiently limit their issuance (without trusting the token issuer) without a centralized service.

Token distribution may be used to delegate access rights in a decentralized or distributed computing system. A token issuer (TI) may typically be a centralized service (potentially load balanced), which results in clients and service providers in the distributed computing system being dependent on an “always-on” token issuer. In computing environments such as the “Internet of Things” (IoT) and decentralized ad-hoc networks, there may not be an “always-on” token issuer service.

This disclosure describes a method for managing token distribution via an entity capable of issuing cryptographic tokens (e.g. a group of transient TI devices) using a blockchain smart contract maintained by an endpoint device or group of endpoint devices (which may be termed “blockchain maintainers”) in a distributed computing environment. The smart contract may be used to both enforce token issuance policy and record token-related events. In addition, other rules may be included in the blockchain smart contract that can be useful for cryptographic protocols.

Certain examples disclosed herein provide methods and devices which may address challenges concerning managing token distribution in edge computing environments of service providers. An “edge environment” may be taken to be a distributed computing system in which computation is largely or completely performed on distributed device nodes, which may be labelled “smart devices” or “edge devices,”. This is in contrast to a system where a centralized cloud environment is used to perform the bulk of computation.

In this disclosure, the word “token” refers to a cryptographic token that can be used for authorisation in cryptographic protocols, allowing its holder to have the right to access a defined service. The token may be thought of as a form of a security certificate, demonstrating the credentials of the user and that the user has the authorisation to access a particular service. Some examples disclosed herein use blockchain smart contracts to act as a policy enforcement point. Some examples disclosed herein use blockchain smart contracts to act as a logging service for service providers, and/or authorised token issuers. By inserting a blockchain smart contact into a token issuance protocol, the protocol may be improved as discussed below. Some examples disclosed herein may allow for the blockchain to be used for handling token distribution in multiple use cases, such as token distribution for anonymous storage or for anonymous reviews.

In more detail, an authorisation service (e.g., Kerberos) may enforce a policy over access in a distributed network of service providers. However, an edge environment may lack an always-on authorisation service and thus make it difficult to manage the access control policy across a group of endpoint devices offering services. For example, an edge device may offer a storage service, but may be unable to assess whether a user is authorised to use that service. Informing the service provider of a means of authenticating the user is not useful unless a valid authentication policy is also available to the service provider. Moreover, it may be beneficial for policies to be consistent across the administrative domain. To do so in a centralised system, maintaining a local policy on a service provider may be achieved by synchronizing the service provider's policies with those of other service providers, and of the domain's administrator.

Certain examples disclosed herein may address the challenge of enforcing an authorisation policy across the local environment when no permanent or central authorisation service is available. For example, an authorisation policy may specify which users are permitted to use which services, how token issuers should issue access tokens, and how service providers should validate access rights.

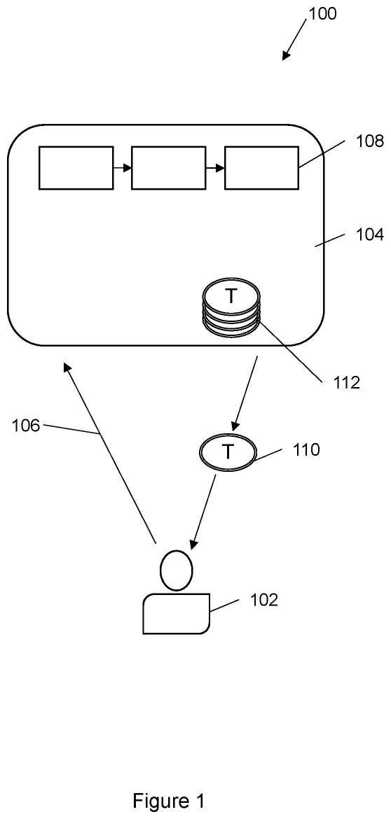

FIG. 1 shows a schematic representation of issuing an authorisation token to a client according to an example of the disclosure. A computing environment 100 comprises a client 102 and a blockchain computing environment 104.

The blockchain computing environment 104 in this example receives a client request 106 for a cryptographic token. The cryptographic token allows the client to access a particular service from a service provider. The blockchain computing environment 104 processes the request 106 using a blockchain 108 smart contract to determine if the client request 106 is valid. The smart contract is stored on the blockchain 108. In other words, when the client 102 requests 106 a token, a corresponding transaction is sent to the smart contract on the blockchain 108.

A smart contract may be considered a computerised transaction protocol that executes the terms of a contract. A blockchain smart contract is a smart contract stored in/set on a blockchain. For example, a smart contract may comprise a computer program to directly control the transfer of authorisation tokens between parties under certain conditions as set out in the contract. An example smart contract may contain a policy constraining when and how cryptographic tokens can be queried. The policy may include criteria such as the identity of the requesting entity, a limitation of the number of tokens issued in a period of time, and/or timing constraints. The policy of the smart contract may be updatable by the owner, for example by using smart contract libraries or other mechanisms depending on the blockchain. The policy maintainer may be in charge of defining the initial policy and may be responsible for updating the policy if necessary.

A token issuer (or a plurality of token issuers) may monitor the blockchain and check whenever a client request is passed to the blockchain in a transaction. This can be done by setting a queue within the smart contract representing pending requests.

If the client request 106 is determined to be valid, the client request 106 is included in the blockchain 108. The policy stored in the smart contract can check that any invalid client request 106 is rejected and not included in the blockchain 108. Once a transaction is included in the blockchain 108, it means that the client request 108 passed the policy rules set in the smart contract, and that the maintainer of the blockchain agrees on that fact (because consensus has been reached by producing the block).

In response to inclusion of the valid client request 106 in the blockchain 108, the requested cryptographic token 110 is generated for provision to the client 102. This may be performed by a token issuer 112. The token issuer 112 may, in some examples, be a token generation module 112 within the blockchain computing environment 104. The token issuer 112 may, in some examples, be a token issuing computer. Such a token issuing computer may be a single computer or a plurality of computers.

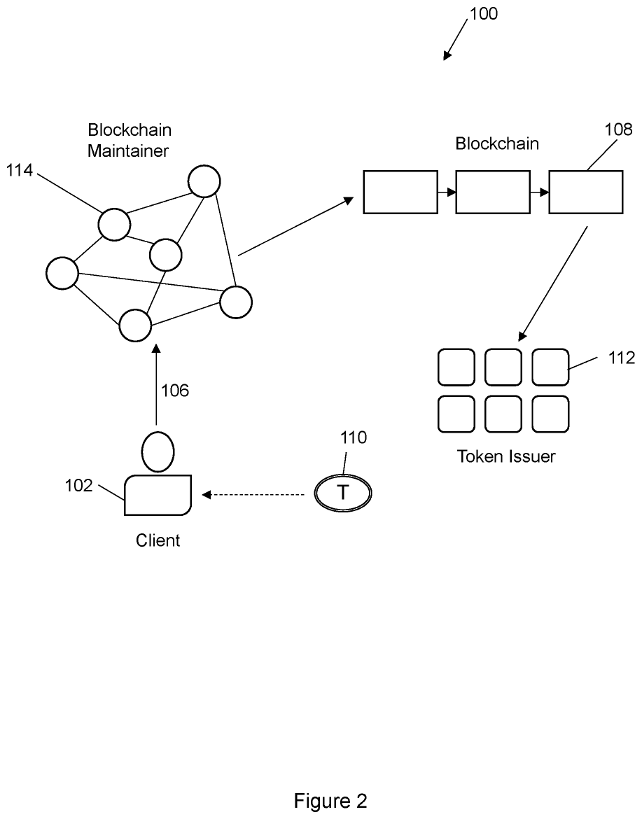

The maintenance and monitoring of the blockchain 108, as well as the generation and issuance of a token for a requesting client, may in some examples both be performed by the same computing entity. In FIG. 1 this entity 104 is called the “blockchain computing environment”. The maintenance and monitoring of the blockchain 108 in some examples may, in some examples, be performed by a different computing entity to that which performs generation and issuance of a token for a requesting client. This is discussed in more detail with reference to FIGS. 2-5 which discuss a blockchain maintainer which is separate from a token issuer. However, all examples disclosed herein may be performed with either a single “blockchain computing environment” 104 to maintain and monitor the blockchain 108 and generate and issue the tokens 110, or, with separate entities (a “blockchain maintainer” to maintain and monitor the blockchain 108 and another “token issuer” to generate and issue the tokens 110).

The blockchain computing environment 104, the blockchain maintainer 114, and/or the token issuer 112 in some examples may be a processor, an apparatus comprising a processor in communication with a storage medium storing instructions/computer program code, instructions/computer program code stored on a computer readable medium, or a combination of these. That is, examples disclosed herein may be realised in the form of hardware, software or a combination of hardware and software. Any such software may be stored in the form of volatile or non-volatile storage such as a storage device like a ROM, whether erasable or rewritable or not, or in the form of memory such as RAM, memory chips, device or integrated circuits or on an optically or magnetically readable medium such as, for example, a CD, DVD, magnetic disk or magnetic tape. When realized as software, the software may be stored on a non-transitory computer-readable medium. Storage devices and media are examples of machine-readable storage that are suitable for storing a program or programs which may, when executed, implement examples discussed herein.

The use of a smart contract may allow for the limitation of cryptographic token throughput, for example by defining a maximum number of tokens that can be issued over a predetermined period of time. The use of a smart contract may allow for enforcement of token issuance recording, for example by only allowing on-chain issued tokens to be valid. In this way, the token issuer cannot secretly issue tokens off-chain, because by either the client or the service provider checking the issued token against the blockchain, it would be seen that the issued token is not valid.

The use of a smart contract may allow for time-limited tokens to be issued. That is, an issued token may by valid only for a certain period of time. This may allow for the number of tokens available within a time window to be monitored. The use of a smart contract may allow for rounds of token issuance to be set up, whereby tokens are issued to clients only within a predetermined “short” period of time (e.g. one day). This may be useful for anonymous protocols, where plural clients may wish to query their respective tokens at the same time to avoid traceability (and remain anonymous).

Following the above scheme, issuing a cryptographic token may be performed automatically without manual intervention following issuance of the client request to generate and provide the token to the client. In some examples, a trusted enclave may be used to monitor the blockchain 108 and automatically generate and send tokens to clients following determination that the client request 106 for a token 110 is valid.

In some examples, tokens may be recorded within the blockchain 108. In some examples, tokens may be generated by a blockchain maintainer. In such examples, the use of Secure Distributed Computing and Trusted Execution Environments (TEE) facilitates the recordal and generation of tokens by ensuring that no external unauthorised activity is allowed to interfere with the recordal and generation of tokens.

FIG. 2 shows a schematic representation of issuing an authorisation token to a client according to an example of the disclosure.

FIG. 2 shows a system as in FIG. 1, with the entity maintaining the blockchain 114 (the “blockchain maintainer”) and the entity issuing the tokens 112 (the “token issuers”) illustrated as separate computers. The system 100 in FIG. 2 comprises a blockchain maintainer 114 which is illustrated as a plurality of connected computers, but in other examples may be a single computer, which may cooperate with other blockchain maintainers. In some examples, the blockchain maintainer 114 is a decentralized edge computer. In some examples, the blockchain maintainer 114 is a plurality of decentralized edge computers in communication with each other.

The client 102 asks for a token 110 to be authorised for release for their use so that they can access a service. This may be considered in some examples as the client 102 sending a token request transaction 106 to the blockchain 108. The blockchain maintainer 114 can receive the client request 106 for a cryptographic token. One role of the blockchain maintainer is to maintain the blockchain via a consensus protocol. That is, changes are allowed to the blockchain if there is consensus from the computer(s) of the blockchain maintainer 114. As before, the cryptographic token allows the client 102 to access a particular service from a service provider. The blockchain maintainer 114 can process the request 106 using a blockchain smart contract stored on a blockchain 108 to determine if the client request is valid. Processing the request 106 may comprise the blockchain maintainer 114 running the transaction/token request through the smart contract stored on the blockchain 108. Using the policy defined on the blockchain 108, the smart contract evaluates if the client request 106 is valid or not.

In some examples, the client may validly request a token when it is part of a predetermined group of clients. For example, the client may be part of a group of clients who are collectively allowed to access a service. The client request may be considered valid, and thus be included in the blockchain if all the members of the group of clients endorse the same token request. For example, access to a particular company record may be contingent on a majority number of members of a company board requesting access. As another example, a valid request may include a threshold number of “signatories” (authorised requesting users) to grant access to the service to the authorised users, such as two out of three users.

The policy defined on the blockchain 108 may be defined and maintained by a policy maintainer. The policy maintainer maintains the policy which defines when and how tokens are issued. The policy maintainer in some examples may be a blockchain maintainer 114 computer. The policy maintainer in some examples may be a centralised computer separate from the blockchain maintainer 114 and token issuers 112. It may be that policies do not change often (for example, they may not change over the course of tens or hundreds of client requests, or may not change over the course of weeks or months). Thus, it may be possible to set a policy, at a centralised or a decentralised computer, and once set, the policy is distributed in the blockchain computing environment. Having a policy stored in a decentralised manner (after setting the policy), as opposed to only at a central storage computer, allows for access to the policy for use in token issuance even if one computer is not available.

Then the blockchain maintainer 114 comes to a consensus on whether to include the client request/transaction in the blockchain (this is a valid request) or not (this is an invalid request). If the client request is determined to be valid, the blockchain maintainer 114 can include the client request in the blockchain 108. If the client request is determined to be invalid, the blockchain maintainer 114 may not include the client request in the blockchain 108. In some examples, transactions or blocks may be marked as invalid and be included in the blockchain. Because transactions are signed, logging bad attempts allows for use of the non-repudiation property of cryptographic signatures to prove that a client indeed attempted to request a certain right (and e.g. was refused).

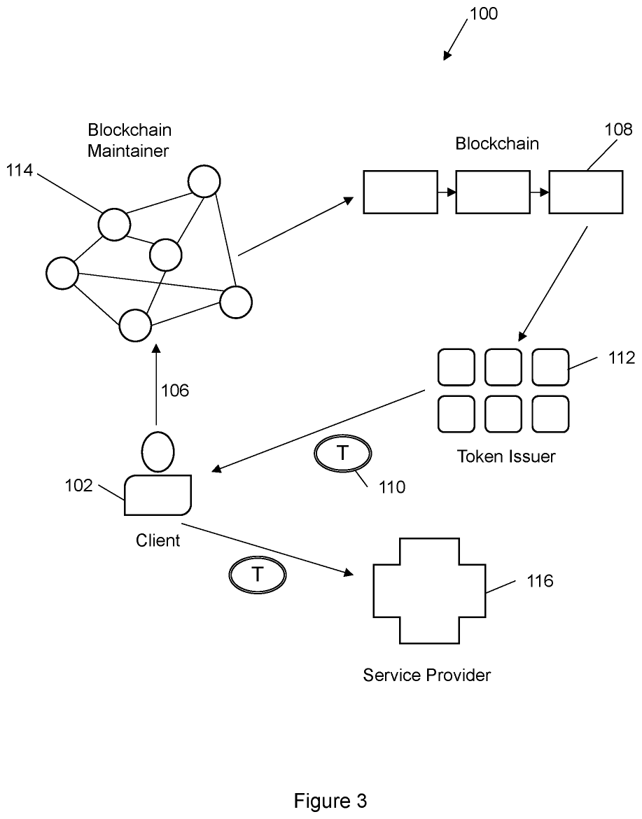

The system 100 in FIG. 2 also comprises a token issuer 112 which is illustrated as a plurality of computers, but in other examples may be a single computer. The token issuers 112 may monitor the blockchain 108 and detect whenever a valid request has been registered. That is, the cryptographic token 110 is generated for the client 102 in response to inclusion of the valid client request 106 in the blockchain 108. In some examples, the token issuers 112 generate the token 110. In some examples, the blockchain maintainer 114 generates the token 110. This is discussed more in relation to FIGS. 3-5.

FIG. 3 shows a schematic representation of issuing an authorisation token to a client according to an example of the disclosure. FIG. 3 follows on from FIG. 2 and provides an example of the token issuer 112 providing the requested token 110 directly from the token issuer 112 to the client 102. The client 102 can then use the received token 110 to access a service at a service provider 116. The service provider 116 provides a service to a client 102 providing an authorised token. The token 110 in this example is not itself recorded in the blockchain (though the client request for the token is recorded in the blockchain).

The token issuer 112 in this example comprises a trusted enclave. The trusted enclave may monitor the blockchain 108 for client requests, and automatically generate and issue the requested cryptographic token 110 in response to inclusion of the valid client request in the blockchain 108. A trusted enclave may be thought of as a computer, computer module or execution environment in which any code executed is trusted to be executed correctly (e.g. without any tampering being possible to the code). It may be hardware, software, or both, and the code may be executed automatically, or based on user input. The code may be trusted to run exactly as expected. By using a trusted enclave, the token issuer cannot “cheat” and issue a token when a token should not be issued (e.g. when the client is not authorised to access the requested service).

Thus, as shown in FIG. 3, if the token 110 isn't recorded on-chain (i.e. is not recorded in the blockchain 108), the client 102 can use the token 110 to access the service from the service provider 116 and the token is assumed to be valid by the service provider 116 and is accepted to allow the client 102 to access the requested service.

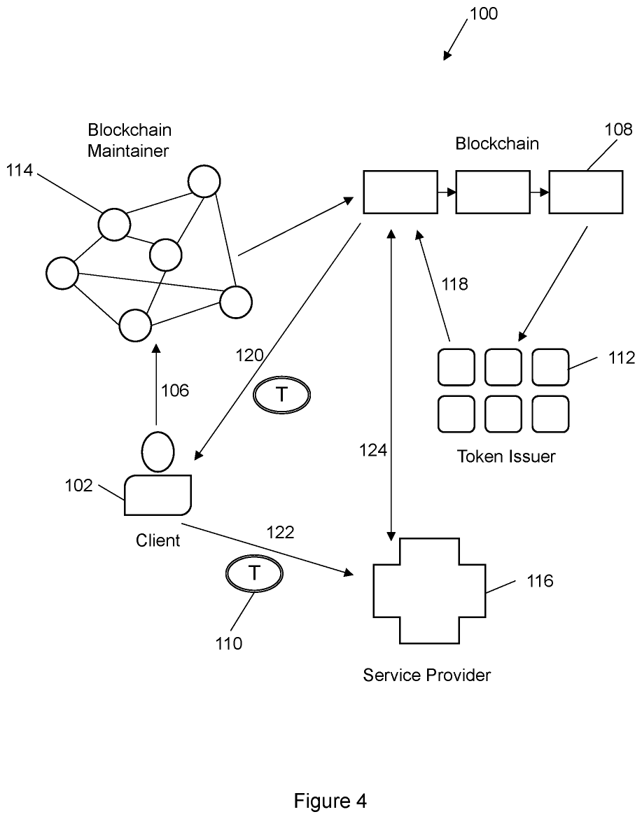

FIG. 4 shows a schematic representation of issuing an authorisation token to a client according to an example of the disclosure. FIG. 4 follows on from FIG. 3 and provides an example of the token issuer including 118 the cryptographic token in the blockchain 108 for subsequent access 120 by the client 102. The client can then use 122 the received token 110 to access a service at a service provider 116. In this example, when the client 102 provides 122 the issued token 110 to the service provider 116 to access a service, the service provider 116 can check 124 the blockchain 108 to determine if the client's token 110 adheres to validity rules specified in the blockchain smart contract.

By including 118 the token 110 in the blockchain 108 (e.g. within a smart contract), all issued tokens 110 can be recorded in the blockchain 108. For example, first, the client request for a token is recorded in the blockchain 108. Following token generation, the token 110 may be stored in the blockchain. This may allow, for example, a service provider 116 to keep a record of how many authorisations have been made, by way of generated tokens, for access to the service of the service provider.

By including the token 110 in the blockchain 108, it is possible to enforce validity rules which govern the use or validity of the token by the client. In other words, in this example, the validity of the issued cryptographic token 110 may be checked using at least one validity rule when the client 102 requests access 122 to the particular service from the service provider 116. The service provider 116 may check 124 at least one validity rule recorded in the blockchain smart contract 108 to verify the validity of the issued cryptographic token 110.

The at least one validity rule may be to check if the requesting client 102 is part of a predetermined client group. For example, if the client is preauthorised as currently being a part of a particular company, and that company is authorised to access the service provided by the service provider, then the issued token may be validated for use and the client may access the service from the service provider. If the client is not, or is no longer, a part of a particular authorised company, then the issued token may be invalid, and the client may not access the service from the service provider. An example of this situation is of an employee who is allowed to access company records and during their employment, they request and are issued with a token. If the employee tries to use the token to access the company records after termination of their employment, the token will be invalid as it belongs to a person who is no longer an employee, and the person cannot access the company records any longer.

As another example, a client may be authorised to access a service if access is co-requested by, and granted to, further clients in a group with the client (for example, a “group signature” may be evaluated to determine if the clients can all access the service). That is, the at least one validity rule may be to check if the client request is made as part of a plurality of co-requests made by the requesting client and a further requesting client. The above example of a client being preauthorised, as currently being a part of a particular company, to request a token is an example of evaluating a “group signature” to validly access a service.

The at least one validity rule may be to check whether a time-limited token (for example, a token valid for accessing a service within a predetermined period from issuance, such as one month) is used to access the service within the specified time limit for use. An example may be to access software offered in a time-limited trial. Comparing the time of issue of the token (which may be recorded in the blockchain) with a validity rule (for example, recorded in the blockchain smart contract) may allow for time-limited tokens to be issued and checked for validity.

As another example, the number of tokens available within a time window may be monitored due to recording of the token issuance in the blockchain.

As shown in FIG. 4, if the token 110 is recorded on-chain (i.e. it was recorded in the blockchain 108), the client 102 can use the token 110 to access the service from the service provider 116. In some examples as illustrated in FIG. 4, the token issuer 112 may still (as in the example of FIG. 3) comprise a trusted enclave to ensure that the token is validly issued to the requesting client. The service provider 116 can check 124 the blockchain 108 to verify an additional rule for the validity of the token 110, rather than assuming without further checking that the token is valid (for example the token may have been validly issued by the trusted enclave token issuer at the time of request, but may not necessarily be valid for use at the time of submitting the token to the service provider due to e.g. too much time elapsing, or lack of an authorised co-requester). Following a check by the service provider that the token 110 adheres to the validity rule, it is accepted to allow the client 102 to access the requested service.

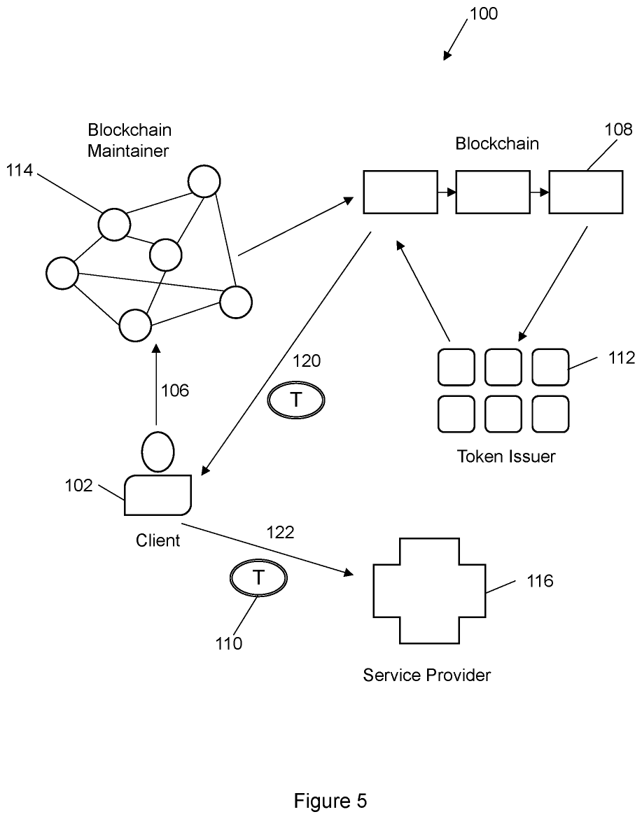

FIG. 5 shows a schematic representation of issuing an authorisation token to a client according to an example of the disclosure. FIG. 5 illustrates a variation of FIG. 4 and provides an example of the token issuer 112 issuing the cryptographic token by including the cryptographic token in the blockchain 108 for subsequent access 120 by the client 102. In this example, the client 102 can retrieve/collect 120 the token from the blockchain 108 rather than the token issuer 112 as in FIG. 3. The service provider 116 in FIG. 5 does not have access (or does not access even if access is available) to the blockchain 108 and thus may not check a validity rule recorded in the blockchain smart contract before accepting the token.

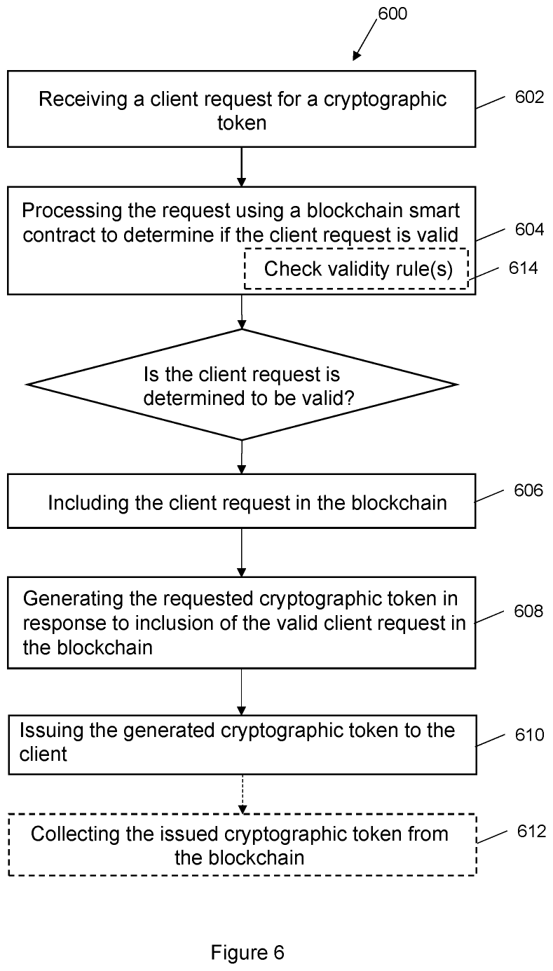

FIG. 6 shows methods according to examples of the disclosure. A method 600 comprises receiving a client request for a cryptographic token 602, the cryptographic token to allow the client to access a particular service from a service provider; processing the request using a blockchain smart contract to determine if the client request is valid 604; if the client request is determined to be valid, including the client request in the blockchain 606; generating the requested cryptographic token in response to inclusion of the valid client request in the blockchain 608; and issuing the generated cryptographic token to the client 610.

The method of FIG. 6 comprises checking validity of the issued cryptographic token using at least one validity rule when the client requests access to the particular service from the service provider 614, checking validity of the issued cryptographic token using at least one validity rule recorded in the blockchain 614, and collecting the issued cryptographic token from the blockchain 612. In other examples, an element or elements from the method of FIG. 6 described above may be omitted.

Also disclosed herein is a non-transitory computer readable storage medium having executable instructions stored thereon, which, when executed by a blockchain maintainer, cause the blockchain maintainer to: receive a client request for a cryptographic token, the cryptographic token to allow the client to access a particular service from a service provider; process the request using a blockchain smart contract to determine if the client request is valid; and include the client request in the blockchain if the client request is determined to be valid; the inclusion of the valid client request in the blockchain allowing for generation of the requested cryptographic token for issuance of the cryptographic token to the client.

In other examples, the non-transitory computer-readable storage medium may comprise program code to perform any of the methods illustrated in FIG. 6.

Examples disclosed herein (see in particular FIGS. 3 and 5) do not use the service provider 116 to query or otherwise access the blockchain 108, because communication with the blockchain 108 is provided by the token issuer 112. The service provider 116 therefore may verify an access token to allow a client 102 to access a service. By removing the need for the service provider 116 to access the blockchain 108 directly in such examples, the system may be simpler (and thus may be less prone to errors) over a system in which a service provider may query to determine if a client is authorised to access a service. Such a system may also provide flexibility, since it may operate without a central service.

Service provider(s) of examples disclosed herein may not be listed on the blockchain. This may provide improved privacy for clients and service providers as the service provider is not listed on the blockchain which (due to the nature of blockchain) is accessible by the blockchain maintainer (which may comprise a plurality of computing entities).

Implementing systems such as those disclosed above as distributed computing systems (for example, a blockchain maintaining computing entity of one, or more than one, computer, which is separate from a token issuer of one, or more than one, token issuer computer, again separate from a policy maintainer computer, and separate from a service provider) may allow for computing systems which operate without reliance on a centralized computer. Therefore, issues relating to a centralized service computer system being unusable if the centralised computer is unavailable may be mitigated since in a distributed system, if one computer fails, there may be another computer able to fulfil the same role as the failed computer.

For example, in an “Internet of Things” arrangement, IoT devices may not always be able to rely on a permanent connection to a central authority, making it difficult to set up centralization constraints. As a result, distributed architectures such as blockchain-based solutions as discussed above may be valuable, and may be able to provide a fully available and autonomous token distribution service.

Examples disclosed herein may allow for access control to be provided for a plurality of devices due to an accessible blockchain providing a trusted smart contract maintained by the blockchain maintainer(s). In some examples it is possible to enforce “cross-device” rules, as specified in the smart contract. For example, two separate clients 102 may each request access to a service, and token issuance may be provided and enforced on the basis of a rule specified in the smart contract such as “each client is allowed access alone but both clients may not access the service at the same time”.

Certain examples disclosed herein may allow for the client to access the service from the service provider in a “private” manner, because the token requested by the client is not necessarily directly related to the client's persistent identity. For example, a client can make a request which is stored on the blockchain. The token issuer can issue a token and store it on the blockchain for later transmission to, or collection by, the client. However, the token need not necessarily be linked to the client's identity, but may be linked to the blockchain-recorded request for a token (which may have been made to an ephemeral pseudonym belonging to the user/client).

Examples as discussed above may remove some trust assumptions about the token issuers and the service provider by using the blockchain to record a smart contract, making use of examples discussed above an option in centralized cases. That is, by recording the client request on the blockchain (and in some examples, recording the issued token in the blockchain), a record is maintained of the requests (and in some examples, of the issuance of tokens). By making the blockchain recording and enforcing the use of tokens, it reduces the need for trusted parties and allows more options to be set up thanks to the possibilities that smart contracts offer, like auditing and transparency.

Some examples described above may allow for the use of decentralized edge computing environments, which may be useful for certain user groups, such as small enterprises and new edge environments, where it may not be feasible to host a full-time management service. Moreover, examples described herein may provide a backup so that an operational system can still be provided if a cloud solution is unavailable (for example, by removing the reliance on a centralised cloud and using distributed blockchain maintainers and/or token issuers). Examples disclosed herein may also provide flexibility and auditability for computing solutions that need to grow and incorporate future designs and scenarios due to transactions being securely recorded on the blockchain.

All of the features disclosed in this specification (including any accompanying claims, abstract, and drawings) may be combined in any combination, except combinations where some of such features are mutually exclusive. Each feature disclosed in this specification, including any accompanying claims, abstract, and drawings), may be replaced by alternative features serving the same, equivalent, or similar purpose, unless expressly stated otherwise. Thus, unless expressly stated otherwise, each feature disclosed is one example of a generic series of equivalent or similar features.

The present teachings are not restricted to the details of any foregoing examples. Any novel combination of the features disclosed in this specification (including any accompanying claims, abstract, and drawings) may be envisaged. The claims should not be construed to cover merely the foregoing examples, but also any variants which fall within the scope of the claims.

1. A method comprising:
receiving a client request for a cryptographic token, the cryptographic token to allow the client to access a particular service from a service provider;
processing the request using a blockchain smart contract to determine if the client request is valid;
if the client request is determined to be valid, including the client request in the blockchain;
generating the requested cryptographic token in response to inclusion of the valid client request in the blockchain; and
issuing the generated cryptographic token to the client.

2. The method of claim 1, wherein issuing the cryptographic token comprises providing the token directly from a token issuer to the client.

3. The method of claim 1, wherein issuing the cryptographic token comprises including the cryptographic token in the blockchain for subsequent access by the client.

4. The method of claim 1, comprising checking validity of the issued cryptographic token using at least one validity rule when the client requests access to the particular service from the service provider.

5. The method of claim 1, comprising checking validity of the issued cryptographic token using at least one validity rule recorded in the blockchain.

6. The method of claim 4, wherein the at least one validity rule comprises:
checking if the requesting client is part of a predetermined client group; and/or
checking if the client request is made as part of a plurality of co-requests made by the requesting client and a further requesting client.

7. The method of claim 1, comprising collecting the issued cryptographic token from the blockchain.

8. A system comprising:
a blockchain maintainer to:
receive a client request for a cryptographic token, the cryptographic token to allow the client to access a particular service from a service provider;
process the request using a blockchain smart contract to determine if the client request is valid; and
include the client request in the blockchain if the client request is determined to be valid; and
a token issuer to:
issue the cryptographic token to the client; the cryptographic token generated in response to inclusion of the valid client request in the blockchain.

9. The system of claim 8, wherein the blockchain maintainer is a decentralized edge computer.

10. The system of claim 8, wherein the token issuer is to issue the cryptographic token by providing the token directly to the client.

11. The system of claim 8, wherein the token issuer is to issue the cryptographic token by including the cryptographic token in the blockchain for subsequent access by the client.

12. The system of claim 11, comprising a service provider to check at least one validity rule recorded in the blockchain smart contract to verify the validity of the issued cryptographic token.

13. The system of claim 11 comprising the client, wherein the client is to collect the issued cryptographic token from the blockchain.

14. The system of claim 8, wherein the token issuer comprises a trusted enclave to monitor the blockchain for client requests, and to automatically generate and issue the requested cryptographic token in response to inclusion of the valid client request in the blockchain.

15. A non-transitory computer readable storage medium having executable instructions stored thereon, which, when executed by a blockchain maintainer, cause the blockchain maintainer to:
receive a client request for a cryptographic token, the cryptographic token to allow the client to access a particular service from a service provider;
process the request using a blockchain smart contract to determine if the client request is valid; and
include the client request in the blockchain if the client request is determined to be valid; the inclusion of the valid client request in the blockchain allowing for generation of the requested cryptographic token for issuance of the cryptographic token to the client.
